(19) United States
(12) Patent Application Publication
(10) Pub. No.: US 2025/0002822 A1
(43) Pub. Date: Jan. 2, 2025

(54) LAUNDRY METHOD

(71) Applicant: Conopco, Inc., d/b/a UNILEVER, Englewood Cliffs, NJ (US)

(72) Inventors: Karl Burgess, Prenton, Wirral (GB); Matthew David McDONALD, Birmingham (GB)

(73) Assignee: Conopco, Inc., d/b/a UNILEVER, Englewood Cliffs, NJ (US)

(21) Appl. No.: 18/290,186

(22) PCT Filed: May 18, 2022
(86) PCT No.: PCT/EP2022/063475

§ 371 Date: Nov. 10, 2023

(30) Foreign Application Priority Data
May 25, 2021 (EP) 21175741.4

(51) Int. Cl. C11D 3/386; C11D 3/50; C11D 17/06

(52) U.S. Cl. CPC C11D 3/38645; C11D 3/505; C11D 17/06; C11D 2111/12

(57) ABSTRACT

A method of laundering fabrics wherein a laundry detergent composition and laundry particles are added to the wash stage of a laundry process, the laundry particles comprising: a) cellulase enzyme; and b) carrier material.

### FIELD OF THE INVENTION

The present invention relates to a method of laundering fabrics.

### BACKGROUND OF THE INVENTION

Consumers are becoming more conscious of their individual impact on the environment. One issue is the production of clothes and so called fast fashion leading to clothes being thrown away after few uses. In response to this, consumers are looking for laundry products which keep their clothes looking newer for longer, in particular providing colour care. Various technologies are available to meet this growing demand, one of which are cellulases, which remove pilling from the surface of clothes. Cellulases are traditionally delivered to fabrics in detergents. However cellulases can bring negative effects such as weakening of fibres and colour fade. There remains a need for compositions which can extend the life of clothing while providing less of a negative impact on the fabric structural integrity of the fabric.

### SUMMARY OF THE INVENTION

It has been found that the method of laundering fabrics wherein a detergent and laundry particles comprising a cellulase enzyme are added in the wash, delivers improved fabric care benefits compared to delivering cellulase from a detergent. Improved care benefits may include improved pill removal and/or a reduced reduction in burst strength and specifically colour care or prevention of colour fade. Without wishing to be bound by theory, it is understood that these benefits may be more evident in aged products than freshly manufactured products.

In one aspect of the present invention is provided a method of laundering fabrics wherein a laundry detergent composition and laundry particles are added to the wash stage of a laundry process, the laundry particles comprising:
a. Cellulase enzyme; and
b. Carrier material.

The invention additionally relates to the use of the method as described herein to provide colour care to fabrics.

### DETAILED DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

As used herein “the laundry process” or the “laundry cycle” refers to all stages of the laundry process. A single laundry cycle generally comprises washing, rinsing, drying and using the fabrics, after which the laundry cycle is repeated.

The present invention involves a method of laundering fabrics in which a fabric is treated with a laundry detergent and laundry particles during the wash stage of the laundry process. The laundry particles comprising cellulase and a carrier material. By “treated” it is meant that the laundry detergent and laundry particles are present in the wash liquor. In a most preferred embodiment the laundry particles are placed in the drum of a washing machine prior to the fabric, resulting in enhanced benefits.

Washing may be hand washing or using a washing machine, preferably washing is performed using a washing machine. Following the wash, the fabric may be rinsed. In the rinse a fabric conditioner may be used. The fabric may then be dried; either air dried or dried using a tumble drier. Once dried the fabric may be stored before use or may be used straight away. Once the fabric has been used, it will then be washed again. Preferably in the next wash the fabric is once again treated with a laundry detergent and laundry particles as described herein. Preferably the wash method described herein is repeated in five consecutive washes, more preferably in ten consecutive washes, most preferably in twenty consecutive washes. By “consecutive washes” it is meant consecutive washes of the same individual fabric.

The present invention additionally relates to the use of the method as described herein to extend the life of fabrics. By extending the life of fabrics means to provide benefits colour care, preferably with less of an impact on fabric integrity compared to a detergent comprising cellulase. Colour care means the maintenance of colour or the prevention of colour fade.

This results in the clothes looking newer for longer.

### Laundry Particles

The laundry particles of the present invention comprise cellulase and a carrier material. They may also comprise additional ingredients, preferably the laundry particles further comprise perfumes and/or dyes.

The method of laundering fabrics wherein cellulase is contained in laundry particles, delivers improved fabric care benefits which extend the life of clothes or keeps them looking newer for longer. Fabric care may be provided with a reduced impact on the fabric structural integrity compared to cellulase delivered from a detergent. The structural integrity can be assessed by the fabric burst strength. Burst strength may be measured using ISO 13938-2:2019 ‘Pneumatic method for determination of bursting strength and bursting distension’. In summary a test specimen is clamped over an expansive diaphragm by means of a circular clamping ring. Increasing air pressure is applied to the underside of the diaphragm, causing distension of the diaphragm and the fabric. The pressure is increased smoothly until the test specimen bursts. The bursting strength and bursting distension are determined.

Suitable cellulases for use in the laundry particles include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia ferresfris, Myce/iophfhora fhermophi/la, and Fusarium oxysporum disclosed in U.S. Pat. Nos. 4,435,307, 5,648,263, 5,691,178, 5,776,757, WO 89/09259, WO 96/029397, and WO 98/012307. Commercially available cellulases include Celluzyme™, Carezyme™ Endolase™, Renozyme™ (Novozymes A/S), Clazinase™ and Puradax HA™ (Genencor International Inc.), and KAC-500(B)™ (Kao Corporation). The cellulase, as disclosed herein, may preferably have a molecular weight of from about 17 kDa to about 30 kDa. Preferably the cellulase comprises a cellulose binding domain (CBD).

Preferably the laundry particles comprise 0.00005 to 1.5 wt. % cellulase, more preferably 0.0001 to 1 wt. %, even more preferably 0.0005 to 0.5 wt. %, most preferably 0.001 to 0.4 wt. % cellulase by weight of the laundry particle.

Preferably the cellulase is present in the wash liquor in a level of 0.00005 to 20 ppm cellulase, more preferably 0.001 to 10 ppm, even more preferably 0.005 to 8 ppm, most preferably 0.01 to 5 ppm of the wash liquor. The wash liquor is formed in the wash stage and comprises the wash water, laundry detergent, laundry particles and any other formulations present in the wash stage. The assessment of inclusion levels in the wash liquor are made once the laundry particles are fully dissolved.

Depending on the intended frequency of use of the laundry particles, they may comprise different quantities or active levels of enzymes. For a product intended to be used frequently, lower levels of cellulase and/or cellulase activity are preferred, whereas if the product is intended as an infrequent or one off fabric care fix, higher levels of cellulase are preferred.

For frequent use, for example five consecutive washes of the same fabric, preferably the laundry particles comprise 0.00005 to 0.1 wt. % cellulase, more preferably 0.0001 to 0.75 wt. %, even more preferably 0.0005 to 0.45 wt. %, most preferably 0.001 to 0.3 wt. % cellulase by weight of the laundry particle.

For a single or one off dose preferably the laundry particles comprise 0.0005 to 1.5 wt. % cellulase, more preferably 0.001 to 1 wt. %, even more preferably 0.005 to 0.5 wt. %, most preferably 0.01 to 0.4 wt. % cellulase by weight of the laundry particle.

For frequent use, for example five consecutive washes of the same fabric, preferably the cellulase is present in the wash liquor in a level of 0.00005 to 10 ppm, more preferably 0.001 to 7.5 ppm, even more preferably 0.005 to 4 ppm, most preferably 0.01 to 3 ppm of the wash liquor.

For a single or one off dose preferably the cellulase is present in the wash liquor in a level of 0.005 to 20 ppm, more preferably 0.01 to 10 ppm, even more preferably 0.05 to 8 ppm, most preferably 0.1 to 5 ppm of the wash liquor.

The laundry particles of the present invention comprise carrier materials. By carrier material is meant a solid material which provides the solid structure of the laundry particle. The compositions described herein preferably comprises at least 50 wt. % carrier materials, preferably 65 wt. %, more preferably 80 wt. % and most preferably at least 90 wt. % carrier materials, by weight of the composition.

Generally, carrier materials may be any material which disperses, dissolves, disintegrates or solubilises in water. The composition my comprise one carrier material or a combination of different carrier materials.

Suitable carrier materials may be selected from the group consisting of: synthetic polymers (e g, polyethylene glycol, ethylene oxide/propylene oxide block copolymers, polyvinyl alcohol, polyvinyl acetate, and derivatives thereof), proteins (e.g., gelatin, albumin, casein), saccharides (e.g. dextrose, fructose, galactose, glucose, isoglucose, sucrose), polysaccharides (e.g., starch, xanthan gum, cellulose, or derivatives thereof), water-soluble or water dispersible fillers (e.g. sodium chloride, sodium sulfate, sodium carbonate/bicarbonate, zeolite, silica, clay), vegetable soap (e.g. coconut soap beads or palm soap), ethoxylated non-ionic surfactants (having a formula R₁O(R₂O)xH, wherein R₁ preferably comprises 12 to 20 carbon atoms, R₂ is C₂H₄ or mixture of C₂H₄ and C₃H₆ units and x=8 to 120), urea and combinations thereof.

Examples of suitable carrier materials include: water soluble organic alkali metal salt, water soluble inorganic alkaline earth metal salt, water soluble organic alkaline earth metal salt, water soluble carbohydrate, water soluble silicate, water soluble urea, starch, xanthan gum, dextrose, clay, water insoluble silicate, citric acid carboxymethyl cellulose, fatty acid, fatty alcohol, glyceryl diester of hydrogenated tallow, glycerol, polyvinyl alcohol, non-ionic surfactants sold under the trade name Lutensol ex. BASF and combinations thereof. Preferred carrier materials may be selected from the group consisting of synthetic polymers (e g, polyethylene glycol, ethylene oxide/propylene oxide block copolymers, polyvinyl alcohol, polyvinyl acetate, and derivatives thereof), polysaccharides (e.g., starch, xanthan gum, cellulose, or derivatives thereof), saccharides (e.g., dextrose, fructose, galactose, glucose, isoglucose, sucrose), vegetable soap (e.g. coconut soap beads or palm soap), urea, ethoxylated non-ionic surfactants (having a formula R₁O(R₂O)xH, wherein R₁ preferably comprises 12 to 20 carbon atoms, R₂ is C₂H₄ or mixture of C₂H₄ and C₃H₆ units and x=8 to 120) and combinations thereof.

More preferably carriers are selected from polyethylene glycol, starch, dextrose, coconut soap beads, palm soap, urea and combinations thereof.

Saccharides are molecular compounds comprising carbon, hydrogen and oxygen. For the purposes of this invention a saccharide is defined as comprising one to ten monosaccharide units and mixtures thereof. In other words either a monosaccharide or an oligosaccharide or mixtures thereof. An oligosaccharide is a short saccharide polymer, typically considered in the art to comprise between two and ten monosaccharides units. It is preferred that a saccharide comprises 1 to 5 monosaccharide units, more preferably 1 to 4 monosaccharide units, most preferably the saccharide comprises monosaccharides, disaccharides or mixtures thereof. Disaccharides are the product of a reaction between two monosaccharides. They may be formed from two identical monosaccharides or two different monosaccharides. Examples of disaccharides include: sucrose, maltose, lactose. Monosaccharides are simple sugar units having the general formula (CH₂O)ₙ. Commonly n is 3, 5 or 6. According, monosaccharides can be classified by the number n, for example: trioses (e.g. glyceraldehyde), pentoses (e.g. ribose) and hexoses (e.g. fructose, glucose and galactose). Some monosaccharides may be substituted with additional functional groups, e.g. Glucosamine, others may have undergone deoxgenation and lost an oxygen atom e.g. deoxyribose. Therefore, the general chemical formulae can vary slightly depending on the monosaccharide.

Preferred monosaccharides for the present invention are hexose molecules (n=6). Hexose molecules all have the same molecular formula, however, have a different structural formula, i.e. are structural isomers. It is preferred that the hexose comprises a 6-membered ring, opposed to a 5 membered ring. Glucose and galactose have 6-membered rings. In a preferred embodiment the hexose monosaccharide is glucose. Glucose is a chiral molecule, having a mixture of D and L stereo isomers. Particularly preferably, the glucose of the present invention is the D isomer of glucose, also known as dextrose.

Preferably a saccharide material used in the present invention is anhydrous, i.e. free of any water. For example, dextrose monohydrate contains one molecule of water whereas anhydrous dextrose contains none.

Non-limiting examples of suitable saccharides for the present invention are: C*Dex ex Cargill, Treha ex Cargill, Anhydrous Dextrose ex Foodchem.

In all compositions, particularly those comprising a saccharide, it may be preferable to include bitter material such as Bitrex ex Johnson Matthey Fine Chemicals, due to the sweetness of the saccharide.

Preferred synthetic polymers for the present invention include polyethylene glycols. Preferably the polyethylene glycol has a weight average molecular weight between 3000 and 14000, preferably between 4000 and 12000.

The laundry particles of the present invention preferably comprise perfume. The perfume may be a free oil perfume and/or perfume microcapsules.

Preferably the compositions of the present invention comprise 0.5 to 30 wt. % perfume ingredients, more preferably 1 to 20 wt. % perfume ingredients, most preferably 2 to 15 wt. % perfume ingredients. By perfume ingredients it is meant the combined free perfume and any encapsulated perfume.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Preferably a perfume composition will comprise a mixture of blooming and substantive perfume components. The perfume composition may comprise other perfume components.

It is commonplace for a plurality of perfume components to be present in a perfume composition. In the compositions for use in the present invention it is envisaged that there will be three or more, preferably four or more, more preferably five or more, most preferably six or more different perfume components. An upper limit of 300 perfume ingredients may be applied.

Free perfume may preferably be present in an amount from 0.01 to 28 wt. %, more preferably 0.1 to 20 wt. %, more preferably from 0.1 to 15 wt. %, even more preferably from 0.1 to 10 wt. %, most preferably from 0.5 to 6 wt. %, based on the total weight of the composition.

Preferably some of the perfume components are contained in a microcapsule. Suitable encapsulating materials may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume components contained in a microcapsule may comprise odiferous materials and/or pro-fragrance materials.

Particularly preferred perfume components are as described for free perfumes.

Encapsulated perfume may preferably be present in an amount from 0.01 to 25 wt. %, more preferably 0.1 to 20 wt. %, more preferably from 0.1 to 15 wt. %, even more preferably from 0.1 to 10 wt. %, most preferably from 0.5 to 6 wt. %, based on the total weight of the composition.

The laundry particles preferably comprise a dye. The dye preferably has a primary purpose of colouring the particles. Suitable dyes are available under the Liquitint tradename from Milliken.

The laundry particles of the present invention may contain further optional laundry ingredients. Such ingredients include cationic polymers, colourants, preservatives, pH buffering agents, perfume carriers, hydrotropes, polyelectrolytes, anti-shrinking agents, anti-oxidants, anti-corrosion agents, drape imparting agents, anti-static agents, ironing aids, antifoams, colorants, pearlisers and/or opacifiers, natural oils/extracts, processing aids, e.g. electrolytes, hygiene agents, e.g. anti-bacterials and antifungals, thickeners, low levels of cationic surfactants such as quaternary ammonium compounds and skin benefit agents.

The laundry particles preferably comprise less than 4 wt. % anionic surfactant, more preferably less than 2 wt. % anionic surfactant, even more preferably less than 1 wt. % anionic surfactant and most preferably 0 wt. % anionic surfactant. In other words, 0 to 4 wt. % anionic surfactant, more preferably 0 to 2 wt. % anionic surfactant, even more preferably 0 to 1 wt. % anionic surfactant and most preferably 0 wt. % anionic surfactant.

The laundry particles may be in any solid form, for example: powder, pellet, tablet, prill, pastille or extrudate. Preferably the composition in the form of a pastille or extrudate. Pastilles can, for example, be produced using ROTOFORMER Granulation Systems ex. Sandvick Materials.

The laundry particle compositions of the present invention may be formed from a melt. The solid composition can for example, be formed into particles by: Pastillation e.g. using a ROTOFORMER ex Sandvick Materials, extrusion, prilling, by using moulds, casting the melt and cutting to size or spraying the melt.

An example manufacturing process may involve melting the carrier material at a temperature above the melting point of that carrier material, preferably at least 2° C. above the melting point of the carrier material, more preferably at least 5° C. above the melting point of the carrier material. Where more than one carrier materials are used, the melting point is considered to the highest of the melting points of the individual materials. Once melted, perfume and other ingredients may be mixed into the compositions. This is followed by a process in which the melt in cooled and shaped, e.g. extrusion or pastillation.

The laundry particle compositions of the present invention are preferably homogeneously structured. By homogeneous, it is meant that there is a continuous phase throughout the solid product. There is not a core and shell type structure. Any particles present such as perfume microcapsules will be distributed within the continuous phase. The continuous phase is provided predominately by the carrier materials.

The laundry particles may be any shape or size suitable for dissolution in the laundry process. Preferably, each individual particle of the solid composition has a mass of between 0.95 mg to 5 grams, more preferably 0.01 to 1 gram and most preferably 0.02 to 0.5 grams. Preferably each individual particle has a maximum linear dimension in any direction of 10 mm, more preferably 0.5-10 mm, more preferably 1-8 mm and most preferably a maximum linear dimension of 4-6 mm. The shape of the particles may be selected for example from spherical, hemispherical, compressed hemispherical, lentil shaped, oblong, or planar shapes such as petals. A preferred shape for the particles is hemispherical, i.e. a dome shape wherein the height of the dome is less than the radius of the base. When the particles are compressed hemispherical, it is preferred that diameter of the substantially flat base provides the maximum linear dimension and the height of the particle is 1-5 mm, more preferably 2-3 mm. The dimensions of the particles of the present invention can be measured using Calipers.

Any amount of laundry particles may be added to the wash. Preferably 5 g to 100 g are added to the wash. More preferably 10 g to 50 g are added to the wash.

Preferably the laundry particles are packaged in a container. When the container is plastic, preferably the container comprises recycled plastic, in particular PCR. “post-consumer resin (PCR)” typically means plastic that has been collected via established consumer recycling streams, sorted, washed and reprocessed, for example into pellets.

### Laundry Detergent

The term “laundry detergent” in the context of the method described herein denotes formulated compositions intended for and capable of wetting and cleaning domestic laundry such as clothing, linens and other household textiles. The laundry detergent may be a liquid or solid composition.

In a preferred embodiment the laundry detergent is a liquid composition. Preferably the liquid composition is isotropic. Pourable liquid detergent compositions preferably have a viscosity of from 200 to 1,500 mPa·s, preferably from 200 to 700 mPa·s.

Preferably, the composition has a pH of 5 to 10, more preferably 6 to 8, most preferably 6.1 to 7.0.

The detergent composition preferably comprises from 5 to 60% and preferably from 10 to 40% (by weight based on the total weight of the composition) of one or more detersive surfactants. The term “detersive surfactant” in the context of this invention denotes a surfactant which provides a detersive (i.e., cleaning) effect to laundry treated as part of a domestic laundering process. “detersive surfactants” include anionic and non-ionic surfactants.

Suitable non-soap anionic-surfactants for use in laundry detergents as described herein are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed. Sodium and potassium are preferred.

Suitable anionic surfactants include; alkylbenzene sulfonates, particularly linear alkylbenzene sulfonates (LAS) with an alkyl chain length of from 10 to 18 carbon atoms; linear alkyl benezene (LAB); alkyl sulfate surfactant (e.g. PAS), such as non-ethoxylated primary and secondary alkyl sulphates with an alkyl chain length of from 10 to 18; alkyl ether sulfates having a straight or branched chain alkyl group having 10 to 18, and containing an average of 1 to 3EO units per molecule (e.g. SLES); C16/18 alkyl ether sulphates; and mixtures thereof.

Preferred anionic surfactants are selected from: linear alkyl benezene sulphonates, sodium lauryl ether sulphonates with 1 to 3 moles (average) of ethoxylation, primary alkyl sulphonates, methyl ether sulphates and secondary alkyl sulphonates or mixtures thereof. A preferred mixture of anionic surfactants for use in the invention comprises linear alkylbenzene sulfonate (preferably C11 to C15 linear alkyl benzene sulfonate) and sodium lauryl ether sulfate. (preferably C10 to C18 alkyl sulfate ethoxylated with an average of 1 to 3 EO).

Suitable non-ionic surfactants include C16/18 alcohol ethoxylates; polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide; aliphatic C8 to C18, more preferably C12 to C15 primary linear alcohol ethoxylates with an average of from 3 to 20, more preferably from 5 to 10 moles of ethylene oxide per mole of alcohol; and mixtures thereof.

A preferred non-ionic surfactant are the C16/18 Alcohol ethoxylates having the formula:

R₁—O—(CH₂CH₂O)_{q}—H

where R₁ is selected from saturated, monounsaturated and polyunsaturated linear C16 and C18 alkyl chains and where q is from 4 to 20, preferably 5 to 14, more preferably 8 to 12.

The detersive surfactants are preferably present in a ratio of detersive surfactant to fabric on a weight to weight basis of from 1:50 to 1:750, preferably 1:100 to 1:600, more preferably 1:150 to 1:500.

The laundry detergents for use in the method described herein may comprise additional ingredients, such as: ethoxylated glycerol esters (comprising an ethoxy group ether bound to each on the hydroxy groups of the glycerol, wherein one, two or three of these ethoxy groups is esterified with a fatty acid), antifoam, preservatives, flourescers, polymeric cleaning boosters such as alkoxylated polyethyleneimines, hydrotropes, co-solvents, phase stabilizers, co-surfactants (such as amphoteric (zwitterionic) and/or cationic surfactants), builders and sequestrants, polymeric thickeners, shading dyes, external structurants (such as include hydrogenated castor oil, microfibrous cellulose and citrus pulp fibre), enzymes, fragrances, microcapsules, foam boosting agents, polyelectrolytes, anti-shrinking agents, anti-wrinkle agents, anti-oxidants, sunscreens, anti-corrosion agents, drape imparting agents, anti-static agents, ironing aids, colorants, pearlisers and/or opacifiers, and shading dye.

Preferably the laundry detergent composition is free from cellulase.

### EXAMPLES

Example compositions of laundry particles as described herein and a laundry detergent suitable for use in the method described herein.

TABLE 1
Laundry particles

| | wt. % active |
|---|---|
| Polyethylene glycol 8000 | 70 |
| Cellulase | 0.1 |
| Starch | 20 |
| Perfume | 6.5 |
| Perfume microcapsules | 3 |
| Minors (including dye) | 0.4 |
| Water | To 100 |

Laundry particles may be prepared by heating the polyethylene glycol to a temperature 5° C. above the melting point to form a melt. The other ingredients may then be mixed in. once fully mixed, the melt maybe poured into moulds and left to cool.

TABLE 2
Laundry detergent

| | wt. % active |
|---|---|
| Lauryl alkyl sodium sulfonate | 3 |
| Sodium lauryl ether sulphate 3EO | 7 |
| Cocamidopropyl betaine | 0.8 |
| Sodium hydroxide | 0.3 |
| Triethanolamine | 0.6 |
| Ethoxylated polyethylineimine | 0.7500 |
| Sodium chloride | 2 |
| Enzymes (excluding cellulase) | <0.5 |
| Perfume | 0.2 |
| Minors | <1 |
| Water | To 100 |

### Colour Care Assessment:

TABLE 3
Laundry detergent compositions

wt. % active

| | A | 1 |
|---|---|---|
| Mono propylene glycol | 2.0 | 2.0 |
| Non-ionic surfactant - C12-14 alcohol | 6.18 | 6.18 |
| ethoxylate, 7 EO | | |
| Triethanolamine | 5.290 | 5.290 |
| Lauryl alkyl sodium sulfonate | 8.240 | 8.240 |
| Faty acids | 1.31 | 1.31 |
| Sodium lauryl ether sulphate 3EO | 6.18 | 6.18 |
| Cellulase enzyme | 0.258 | 0 |
| Minors (antifoam, preservatives, etc.) | <1 | <1 |
| Demin water | To 100 | To 100 |

TABLE 4
Laundry particle compositions

wt. % active

| | B | 2 |
|---|---|---|
| Polyethylene glycol 8000 | 65 | 65 |
| Dextrose | 26.5 | 26 |
| Cellulase enzyme | 0 | 0.520 |
| Fragrance oil | 6.5 | 6.5 |
| Perfume microcapsule | 2 | 2 |

The laundry particles were prepared by the following process. The PEG 8000 was heated to −65° C. The dextrose was added with stirring, followed by the cellulase enzyme, fragrance oil and the microcapsules. The particles were formed by pipetting onto a flat surface.

The wash experiment was carried out as follows: EMPA 252 (non-pilled) colour striped monitors were used for the colour assessment with a mixed ballast. The fabrics were washed using a Miele washing machine on a standard 40′C cotton wash. Into each wash was dosed either laundry detergent A and laundry particles B or laundry detergent 1 and laundry particles 2. The detergent and particles were dosed to ensure the same level of cellulose enzyme was present in the wash liquor of each wash. After each wash cycle, the fabrics were tumble dried. This cycle of washing and drying was repeated 20 times with the same combination or products A and B or 1 and 2. After 20 cycles a colour assessment was carried out.

The colour care was assessed by the change in colour after 20 washes. Colour measurements were taken for each colour stripe on the EMPA test fabric before the first wash to provide a baseline, then after 20 washes. Colour was assessed by the ΔE value before and after washing. AE was calculated using the CIELAB colour space, wherein each colour has an L*, a* and b* value and;

$$Δ E ⋆ ab = √ ( L ⋆ 2 - L ⋆ 1 ) + ( a ⋆ 2 - a ⋆ 1 ) + ( b ⋆ 2 - b ⋆ 1 )$$

The colour assessment was performed using an X-rite colour spectrometer.

| | ΔE black | ΔE blue | ΔE red | ΔE green |
|---|---|---|---|---|
| | stripe | stripe | stripe | stripe |
| Laundry detergent A and | 4.78 | 3.27 | 8.69 | 7.06 |
| Laundry particle B | | | | |
| Laundry detergent 1 and | 4.02 | 2.57 | 8.15 | 5.75 |
| Laundry particle 2 | | | | |

A smaller ΔE demonstrates improved colour care. i.e. less colour fade over 20 washes. For all colours tested the colour change is less when the cellulase is delivered from the laundry particle rather than the laundry detergent.

1. A method of laundering fabrics wherein a laundry detergent composition and laundry particles are added to the wash stage of a laundry process, the laundry particles comprising:
a. cellulase enzyme;
b. carrier material; and
the laundry particles comprise perfume ingredients;
0.00005 to 1.5 wt. % cellulase,
wherein the wash stage involves the formation of a wash liquor, and the wash liquor comprises 0.00005 to 20 ppm cellulase.

2. (canceled)

3. (canceled)

4. The method according to claim 1, wherein the carrier material is selected from the group consisting of: synthetic polymers, proteins, saccharides, polysaccharides, water-soluble or water dispersible fillers, vegetable soap, ethoxylated non-ionic surfactants, urea and combinations thereof.

5. The method according to claim 1, wherein the laundry particles comprise at least 50 wt. % carrier materials.

6. The method according to claim 1, wherein the laundry particles comprise less than 4 wt. % anionic surfactant.

7. The method according to claim 1, wherein the laundry detergent composition comprises 5 to 60% wt. % of one or more detersive surfactants.

8. The method according to claim 1, wherein the laundry detergent composition is free from cellulase.

9. The method according to claim 1, wherein the laundry detergent composition is a liquid composition.

10. The method according to claim 1, wherein the laundry particles have a maximum linear dimension in any direction of 0.5-10 mm.

11. The method according to claim 1, wherein 5 g to 100 g of laundry particles are added to the wash stage.

12. The method according to claim 1, wherein the method is repeated for five consecutive washes.

13. The method according to claim 1 wherein the laundry detergent further comprises ethoxylated glycerol ester antifoam, preservative, flourescer, alkoxylated polyethylenemine, hydrotrope, co-solvent, phase stabilizer, co-surfactant, builders, sequestrant, polymeric thickener, shading dye, enzyme, fragrance, microcapsule, foam boosting agent, polvelectrolyte, anti-shrinking agent, agent anti-wrinkle agent, anti-oxidant, sunscreen, anti-corrosion agent, drape imparting agent, anti-static agent, ironing aid, colorant, pearliser, opacifier or a mixture thereof.
